(19) United States
(12) Patent Application Publication
(10) Pub. No.: US 2022/0410566 A1
(43) Pub. Date: Dec. 29, 2022

(54) INFORMATION PROCESSING DEVICE, INFORMATION PROCESSING SYSTEM, AND INFORMATION PROCESSING METHOD

(71) Applicants: Yuji TANAKA, Kanagawa (JP); Tetsuyoshi NAKATA, Kanagawa (JP); Hideaki IIJIMA, Kanagawa (JP)

(72) Inventors: Yuji TANAKA, Kanagawa (JP); Tetsuyoshi NAKATA, Kanagawa (JP); Hideaki IIJIMA, Kanagawa (JP)

(21) Appl. No.: 17/778,006

(22) PCT Filed: Nov. 26, 2020
(86) PCT No.: PCT/IB2020/061163

§ 371 Date: May 19, 2022

(30) Foreign Application Priority Data
Jan. 24, 2020 (JP) 2020-010406

(51) Int. Cl. B41J 2/045; G06K 15/02

(52) U.S. Cl. CPC B41J 2/04536; G06K 15/1848; B41J 2/04586

(57) ABSTRACT

An information processing device for generating data to be used by a recording device, which includes a plurality of discharge portions configured to discharge a liquid to form the object on the medium, includes a communication circuit configured to communicate with the recording device; an identifying unit configured to identify, based on a movement direction of the recording device in formation of the object on the medium, an initial pixel of the object formed by an initial discharge of the liquid by each of the plurality of discharge portions; a data generation unit configured to generate discharge control data for controlling a discharge operation of each of the plurality of discharge portions for the initial pixel identified by the identifying unit; and a transmission control unit configured to control the communication circuit to transmit the discharge control data to the recording device.

### TECHNICAL FIELD

Embodiments of the present disclosure relate to an information processing device, an information processing system, and an information processing method.

### BACKGROUND ART

In recent years, as laptop personal computers become compact and smart devices have spread, compactness and portability of printers are desired. For example, PTL 1 discloses a handheld printer from which a paper conveyance mechanism is omitted for enhancing compactness and portability.

This handheld printer receives data of image to be printed from, for example, a smart device or a personal computer. A user holds a housing of the handheld printer with hand and operates the printer on a recording medium such as a notebook or paper. As a result, ink is discharged according to the amount of operation, and the image is printed according to the received image data on the recording medium.

### CITATION LIST

### Patent Literature

[PTL 1]
Japanese Translation of PCT International Application Publication No. JP-T-2010-520087

### SUMMARY I/F INVENTION

### Technical Problem

However, the conventional handheld printer has a drawback that a portion of a print object, such as, a printed character, corresponding to a print start position may be missing or blurred, and the print quality is degraded.

### Solution to Problem

In view of the foregoing, an object of the present disclosure is to provide an information processing device, an information processing system, and an information processing method that can prevent a missing or blurred portion at a position of a print object, such as, a printed character, corresponding to the print start position, thereby improving the quality of the printed matter.

In order to achieve the above-described object, there is provided an information processing device for generating data to be used by a recording device to form an object on a medium. The recording device includes a recording head including a plurality of discharge portions configured to discharge a liquid, to form the object on the medium. Advantageously, the information processing device includes a communication circuit configured to communicate with the recording device; and an identifying unit configured to identify, based on a movement direction of the recording device in formation of the object on the medium, an initial pixel of the object formed by an initial discharge of the liquid by each of the plurality of discharge portions. The information processing device further includes a data generation unit and a transmission control unit. The data generation unit is configured to generate discharge control data for controlling a discharge operation of each of the plurality of discharge portions for the initial pixel identified by the identifying unit. The transmission control unit is configured to control the communication circuit to transmit the discharge control data to the recording device.

### Advantageous Effects of Invention

Accordingly, a missing or blurred portion at the position of the print object, such as a printed character, corresponding to the print start position can be prevented, and the quality of the printed matter can be improved.

### BRIEF DESCRIPTION I/F DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating a configuration of a printing system according to a first embodiment of the present disclosure;

FIG. 2 is a block diagram illustrating a configuration of a mobile communication terminal of the printing system illustrated in FIG. 1;

FIG. 3 is a block diagram illustrating a functional configuration of the mobile communication terminal illustrated in FIG. 2;

FIG. 4 is a perspective view of a handheld printer of the printing system according to the first embodiment;

FIG. 5 is a block diagram illustrating a configuration of the handheld printer illustrated in FIG. 4;

FIG. 6 is a block diagram illustrating a hardware configuration of a controller of the handheld printer illustrated in FIG. 5;

FIG. 7 is a sequence chart illustrating a flow of printing operation performed by the printing system according to the first embodiment;

FIG. 8A is a diagram illustrating a print object;

FIG. 8B is a diagram illustrating missing or blurred pixels at a start position of the print object illustrated in FIG. 8A;

FIG. 9 is a diagram illustrating an example of pre-printing performed prior to printing, in order to prevent a missing or blurred pixels in a print object corresponding to the start position, as a comparative example;

FIG. 10 is a block diagram illustrating a detailed functional configuration of a function of the mobile communication terminal illustrated in FIG. 3;

FIG. 11 is a flowchart illustrating a flow of a print data generation operation by the mobile communication terminal of the printing system according to the first embodiment;

FIG. 12 is a schematic diagram of print data generated by the mobile communication terminal of the printing system according to the first embodiment;

FIG. 13A is a schematic diagram illustrating print data generated corresponding to the operation direction of the handheld printer according to the first embodiment;

FIG. 13B is another schematic diagram illustrating print data generated corresponding to the operation direction of the handheld printer according to the first embodiment;

FIG. 14A is another schematic diagram illustrating print data generated corresponding to the operation direction of the handheld printer according to the first embodiment;

FIG. 14B is another schematic diagram illustrating print data generated corresponding to the operation direction of the handheld printer according to the first embodiment;

FIG. 15A is a schematic diagram illustrating an example of print data in which a predetermined number of pixels are subtracted at the print start position of a print object corresponding to a characteristic of a recording head;

FIG. 15B illustrates an example of the print object printed according to the print data illustrated in FIG. 15A;

FIG. 16 is a flowchart illustrating a printing operation of the handheld printer according to a second embodiment;

FIG. 17 is a diagram illustrating a position calculation method of a navigation sensor of the handheld printer illustrated in FIG. 5;

FIG. 18 is a block diagram illustrating a functional configuration of the handheld printer of the printing system according to the second embodiment; and

FIG. 19 is a flowchart illustrating a flow of a print data generation operation by the handheld printer of the printing system according to the second embodiment.

### DESCRIPTION I/F EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, a printing system according to an embodiment of the present disclosure is described with reference to the accompanying drawings.

A first embodiment is described below.

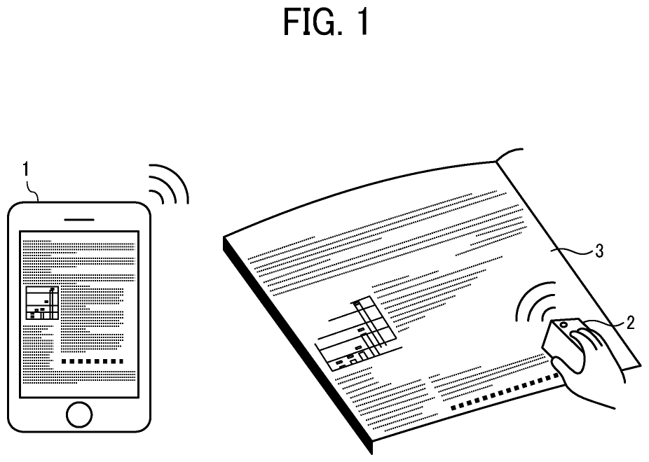

FIG. 1 is a diagram illustrating a configuration of a printing system according to the first embodiment. As illustrated in FIG. 1, the printing system according to the present embodiment includes a mobile communication terminal 1 (an example of an information processing device) and a handheld printer 2 (an example of a printer and a recording device). The mobile communication terminal 1 is, for example, an electronic device, such as a smartphone, a tablet terminal, or a laptop or desktop personal computer, capable of wireless communication (or wired communication). The mobile communication terminal 1 transmits print data of a target to be printed to the handheld printer 2.

The handheld printer 2 is a lightweight and compact printer. As illustrated in FIG. 1, a user holds and operates (i.e., moves), with one hand, the handheld printer 2 on a recording medium 3. According to the amount of operation by the user, the handheld printer 2 prints a character or an image on the recording medium 3 according to the print data received from the mobile communication terminal 1.

Hardware Configuration of Mobile Communication Terminal

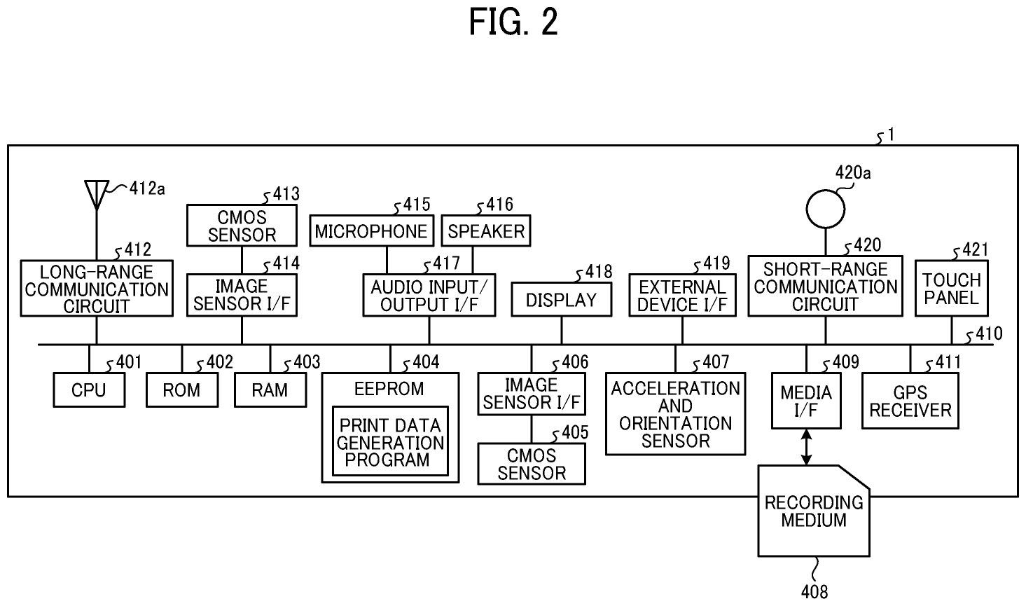

FIG. 2 is a block diagram illustrating a hardware configuration of the mobile communication terminal 1. As illustrated in FIG. 2, the mobile communication terminal 1 includes a central processing unit (CPU) 401, a read only memory (ROM) 402, a random access memory (RAM) 403, an electrically erasable programmable read-only memory (EEPROM) 404, a complementary metal oxide semiconductor (CMOS) sensor 405, an image sensor interface (I/F) 406, an acceleration and orientation sensor 407, a media I/F 409, and a global positioning system (GPS) receiver 411.

The CPU 401 controls the entire operation of the mobile communication terminal 1. The ROM 402 stores programs used by the CPU 401 or used by an initial program loader (IPL) to boot the CPU 401. The RAM 403 is used as a work area for the CPU 401. The EEPROM 404 performs reading or writing of various data such as a mobile communication terminal program under control of the CPU 401.

Further, the EEPROM 404 stores a print data generation program for generating print data to be transmitted to the handheld printer 2. As will be described later, according to the print data generation program, the CPU 401 generates print data that does not cause a missing portion or a blurred portion in the print object corresponding to the print start position, and transmits the print data to the handheld printer 2.

The CMOS sensor 405 generates image data corresponding to image capture light from a subject, under the control of the CPU 401. In addition or alternative to the CMOS sensor, a different image capture device such as a charge-coupled device (CCD) image sensor may be used.

The image sensor I/F 406 is an interface for connecting the CMOS sensor 405 to a bus line 410. Examples of the acceleration and orientation sensor 407 include various sensors such as an electromagnetic compass to detect geomagnetism, a gyrocompass, and an accelerometer. The media I/F 409 is an interface for connecting a recording medium 408 such as a flash memory to the bus line 410. To and from the recording medium 408, for example, print data of an image or the like is written and read out via the media I/F 409. The print data can be stored in another storage area such as the ROM 402 or the RAM 403. The GPS receiver 411 receives a GPS signal from a GPS satellite.

The mobile communication terminal 1 further includes a long-range communication circuit 412, a CMOS sensor 413, an image sensor I/F 414, a microphone 415, a speaker 416, an audio input/output I/F 417, a display 418, an external device I/F 419, a short-range communication circuit 420, an antenna 420a for the short-range communication circuit 420, and a touch panel 421.

As will be described later, the display 418 displays a print data selection screen for selecting desired print data, a print data edit screen, and the like based on the print data generation program. The user selects and edits desired print data on the print data selection screen and the print data edit screen. This configuration facilitates generation of desired print data and transmission of the print data to the handheld printer 2.

The long-range communication circuit 412 communicates with other devices via a communication network 412a. The CMOS sensor 413 captures an image of a subject and generates image data under the control of the CPU 401. The image sensor I/F 414 is an interface for connecting the CMOS sensor 413 to the bus line 410. The microphone 415 generates an audio signal which is an electric signal corresponding to collected voice. The speaker 416 outputs sound such as music or voice corresponding to the audio signal. The audio input/output I/F 417 is a circuit for inputting and outputting an audio signal between the microphone 415 and the speaker 416 under control of the CPU 401.

The display 418, such as a liquid crystal display or an organic electro luminescence (EL) display, displays an image of a subject or various icons. The external device I/F 419 is an interface for connection with various external devices. The short-range communication circuit 420 is a communication circuit in compliance with the near field communication (NFC), the Bluetooth (registered trademark), and the like. The touch panel 421 is disposed on the display 418 and detects a touch (contact operation) of the user.

The mobile communication terminal 1 further includes the bus line 410. The bus line 410 is, e.g., an address bus or a data bus configured to electrically connect the components such as the CPU 401 illustrated in FIG. 2.

Software Configuration of Mobile Communication Terminal

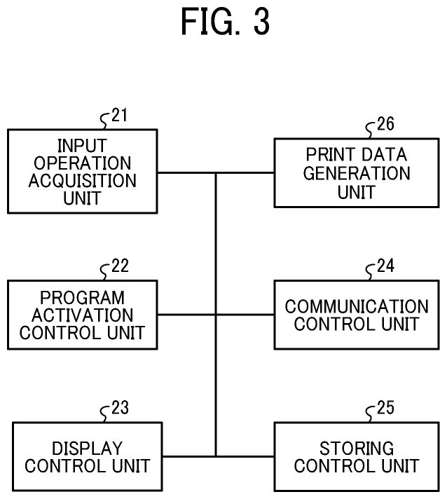

FIG. 3 is a block diagram illustrating functions implemented as the CPU 401 of the mobile communication terminal 1 operates according to the print data generation program. The CPU 401 of the mobile communication terminal 1 executes the print data generation program, thereby functioning as an input operation acquisition unit 21, a program activation control unit 22, a display control unit 23, a communication control unit 24 (a transmission control unit), a storing control unit 25, and a print data generation unit 26.

The input operation acquisition unit 21 acquires the information input by the user via the above-mentioned input screen. The program activation control unit 22 controls activation of the print data generation program. The display control unit 23 displays, on the display 418, the above-mentioned print data selection screen, the print data edit screen, and the like. The communication control unit 24 establishes, via the short-range communication circuit 420, short-range wireless communication such as BLUETOOTH (registered trademark) communication with the handheld printer 2, and transmits the print data to the handheld printer 2.

The storing control unit 25 controls reading of print data to be transmitted to the handheld printer 2, and writing and reading of the information input by the user via the input screen to a storage area such as the RAM 403. The print data generation unit 26 generates print data that does not cause a missing portion or a blurred portion in a portion of the print object corresponding to the print start position.

Although the description above concerns an example in which the input operation acquisition unit 21 to the print data generation unit 26 are implemented by software, alternatively, some or all of these functions can be implemented by hardware such as an integrated circuit (IC).

In another example, the print data generation program is stored in a computer-readable recording medium such as a compact disc read only memory (CD-ROM) and a flexible disk (FD), in an installable or executable file format, for distribution. In still another example, the print data generation program is stored in a computer-readable recording medium such as a compact disc-recordable (CD-R), a digital versatile disk (DVD), a Blu-ray Disc (registered trademark), and a semiconductor memory, for distribution. In still another example, the print data generation program is installed through a network such as the Internet or preloaded in a ROM, etc., of the device.

External Configuration of Handheld Printer

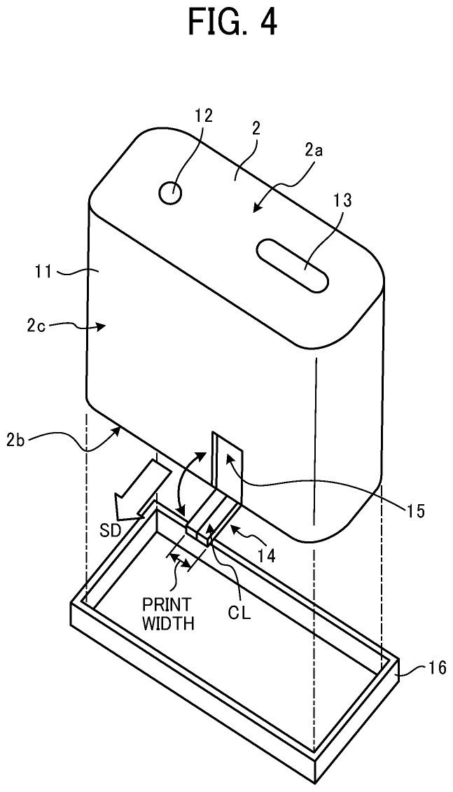

FIG. 4 is a perspective view illustrating an exterior of the handheld printer 2. As illustrated in FIG. 4, the handheld printer 2 includes a box-shaped housing 11 that can be grasped by the user with one hand. A power button 12 and a print start button 13 are disposed on an upper face 2a of the housing 11. The power button 12 and the print start button 13 are light emitting operation buttons using, for example, a light emitting diode (LED). The CPU 401 turns on light of the power button 12 from when the power button 12 is operated until when the power button 12 is operated again (while the power is on).

The print start button 13 also serves as an answerback button when data is received from the mobile communication terminal 1. Specifically, when the CPU 401 receives the print data from the mobile communication terminal 1, the CPU 401 causes the print start button 13 to blink a predetermined number of times, for example, five times, to notify the user of the reception of the print data. Further, when the print start button 13 is operated, the CPU 401 controls printing according to the operation of the handheld printer 2.

An inkjet recording head 33 is disposed on a bottom face 2b of the handheld printer 2. The inkjet recording head 33 performs printing according to the movement of the handheld printer 2 operated by the user. Further, the operation direction (an example of a movement direction) of the handheld printer 2 is usually fixed in the direction indicated by arrow SD in FIG. 4. When the housing 11 is moved in the direction indicated by arrow SD by the user, the inkjet recording head 33 performs printing.

Further, when the housing 11 is moved in a direction other than the direction indicated by arrow SD in FIG. 4, the driving of the inkjet recording head 33 is stopped, and printing is not performed. Note that printing may be permitted in all or some of the directions according to operation direction of the user (switching of the print direction).

Further, a guide 14 is disposed on a lateral side face 2c of the housing 11 facing in the print direction indicated by arrow SD in FIG. 4, so as to project in the print direction (operating direction) indicated by arrow SD. The guide 14 is shaped like a long, rectangular plate. The guide 14 is stored in a storage portion 15 along the lateral side face 2c of the housing 11 when printing is not performed. At the time of printing, when the user hooks his or her finger nail on an upper end of the guide 14 and turns down the guide 14 in the semicircular direction indicated by an arrow, the guide 14 projects in the operation direction indicated by arrow SD from a portion of the lateral side face 2c in the vicinity of the bottom face 2b of the housing 11.

The guide unit 14 has a width that represents a print width in which printing is performed in one operation. At a center of the guide 14, a center line CL extending from the lateral side face 2c toward the operation direction is provided. As one example, this center line CL is a thin red line. As described above, the width of the guide 14 indicates the width printed by one operation. Therefore, the center line CL indicates the center of the width printed by one operation. Therefore, the user aligns the center line CL with the center of the print start position and moves the housing 11. As a result, characters, images, and the like can be printed with the center positions aligned.

Further, the handheld printer 2 includes a head cap 16 that covers the bottom face 2b when printing is not performed. Covering the bottom face 2b with the head cap 16 can prevent the inkjet recording head 33 from extremely drying in a non-printing period and the inconvenience that the inkjet recording head 33 is dusted or scratched.

Hardware Configuration of Handheld Printer

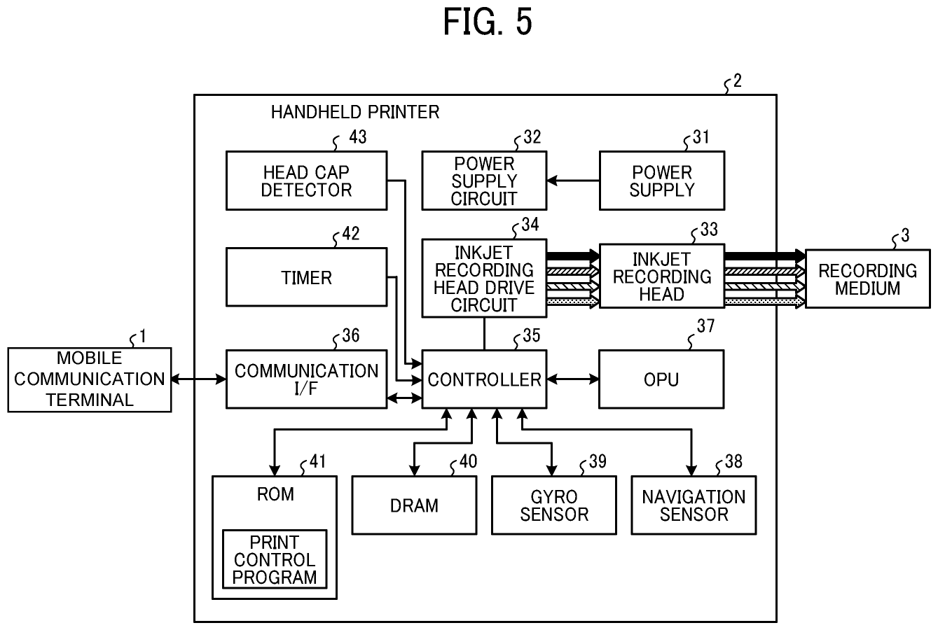

FIG. 5 is a block diagram illustrating a hardware configuration of the handheld printer 2. As illustrated in FIG. 5, the handheld printer 2 includes a power supply 31, a power supply circuit 32, the inkjet (IJ) recording head 33, an inkjet recording head drive circuit 34, a controller 35, a communication I/F 36 (an example of a communication unit), an operation panel unit (OPU) 37, a navigation sensor 38, a gyro sensor 39, a dynamic RAM (DRAM) 40, and a ROM 41. Further, the handheld printer 2 includes a timer 42 and a head cap detector 43.

The power supply 31 is rechargeable and is a so-called secondary battery. The power supply 31 generates a drive power for the handheld printer 2. The power supply circuit 32 supplies the power from the power supply 31 to necessary components. The inkjet recording head 33 discharges ink to the recording medium 3 by an inkjet method, to print characters, images, or the like. The inkjet recording head drive circuit 34 controls driving of the inkjet recording head 33 in accordance with the characters or images to be printed. The controller 35 controls the entire handheld printer 2.

The communication I/F 36 is, for example, an interface circuit for wireless communication with the mobile communication terminal 1 by short-range wireless communication such as BLUETOOTH (registered trademark). The OPU 37 includes a light emitting diode (LED) for displaying the state of the handheld printer 2, a switch for the user to instruct the handheld printer 2 to form an image, and the like. However, the OPU 37 is not limited thereto, and may further include a liquid crystal display or a touch panel. The OPU 37 may further has an audio input capability.

The navigation sensor 38 is configured to detect the amount of movement of the handheld printer 2 in an X-axis direction and in a Y-axis direction. The gyro sensor 39 is configured to detect the angular velocity applied to the handheld printer 2. The DRAM 40 and ROM 41 are storage areas for, for example, print data and data indicating the print direction (print direction data). Further, the ROM 41 stores a print control program and drive waveform data of the inkjet recording head 33.

In the handheld printer 2 having the above-described configuration, in response to reception of print data (print job) from the mobile communication terminal 1, the controller 35 calculates the position of each discharge nozzle (an example of a discharge portion) of the inkjet recording head 33 based on information input from the navigation sensor 38 and the gyro sensor 39. While the user operates the handheld printer 2, the controller 35 continuously calculates the position of each discharge nozzle and acquires only the print data corresponding to the calculated position from the DRAM 40. Then, the controller 35 compares the position of a print portion represented by the acquired print data with the position of each nozzle. When determining the agreement between the compared positions, the controller 35 supplies the print data for the nozzle to the inkjet recording head drive circuit 34.

The inkjet recording head drive circuit 34 supplies print timing information together with the print data to the inkjet recording head 33. Based on the print timing information, the inkjet recording head 33 discharges ink corresponding to the print data onto the recording medium 3. As a result, an image is recorded on the recording medium 3 according to the print data designated by the user.

The head cap detector 43 detects whether or not the head cap 16 is attached to the handheld printer 2. The timer 42 measures the time and supplies measured time information to the controller 35. As will be described later, the controller 35 monitors the dry state of the inkjet recording head 33. When the head cap 16 is not attached, the drying of the inkjet recording head 33 advances rapidly. Therefore, based on the measured time information, the controller 35 determines that the inkjet recording head 33 is dry, for example, in response to reception of measured time information indicating elapse of 30 seconds, and corrects the print data as described later.

By contrast, when the head cap 16 is attached, the drying of the inkjet recording head 33 progresses slowly. Therefore, based on the measured time information, the controller 35 determines that the inkjet recording head 33 is dry, for example, in response to reception of measured time information indicating elapse of 3 minutes, and corrects the print data as described later.

Configuration of Controller

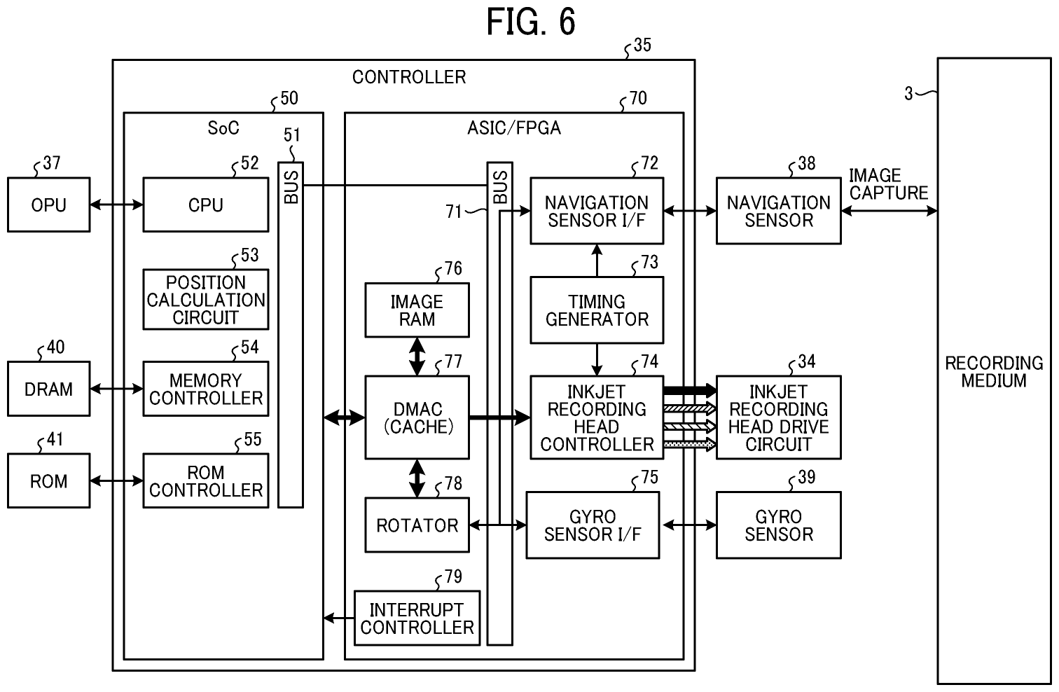

FIG. 6 is a block diagram illustrating a hardware configuration of the controller 35 of the handheld printer 2 illustrated in FIG. 5. As illustrated in FIG. 6, the controller 35 includes a system on chip (SoC) 50 and an application-specific integrated circuit/field-programmable gate array (ASIC/FPGA) 70. The SoC 50 and the ASIC/FPGA 70 is interconnected through respective bus lines 51 and 71.

The SoC 50 includes, in addition to a CPU 52, a position calculation circuit 53 that performs position calculation, a memory controller 54 that controls writing to and reading from an external memory such as a DRAM, and a ROM controller 55 that controls writing and reading of data to and from the ROM 41.

The ASIC/FPGA 70 includes a navigation sensor I/F 72, a timing generator 73 (e.g., a circuit), an inkjet recording head controller 74, a gyro sensor I/F 75, an image RAM 76, a direct memory access controller (DMAC) 77, a rotator 78, and an interrupt controller 79.

The navigation sensor I/F 72 stores a movement amount ΔX in the X-axis direction and a movement amount ΔY in the Y-axis direction of the handheld printer 2 in an internal register. The gyro sensor I/F 75 stores an angular velocity ω received from the gyro sensor 39 in an internal register. The timing generator 73 notifies the navigation sensor I/F 72 of the timing of reading of the information from the navigation sensor 38, and notifies the inkjet recording head controller 74 of the drive timing for printing.

The DMAC (CACHE) 77 and the rotator 78 read the image data around each nozzle of the inkjet recording head 33 from the DRAM 40 (or the ROM 41) based on the position information calculated by the position calculation circuit 53 of the SoC 50. Then, the DMAC (CACHE) 77 and the rotator 78 rotate the read image data according to the position and inclination of the inkjet recording head 33, and supply the read image data to the inkjet recording head controller 74.

The image RAM 76 temporarily stores the print data read from the DRAM 40 by the DMAC (CACHE) 77. The inkjet recording head controller 74 (a discharge control unit) supplies control signals and the print data to the inkjet recording head drive circuit 34. In response to completion of the communication between the navigation sensor I/F 72 and the navigation sensor 38, the interrupt controller 79 notifies the SoC 50 of the completion of the communication therebetween. The interrupt controller 79 also notifies the SoC 50 of a status such as an error.

Printing Operation

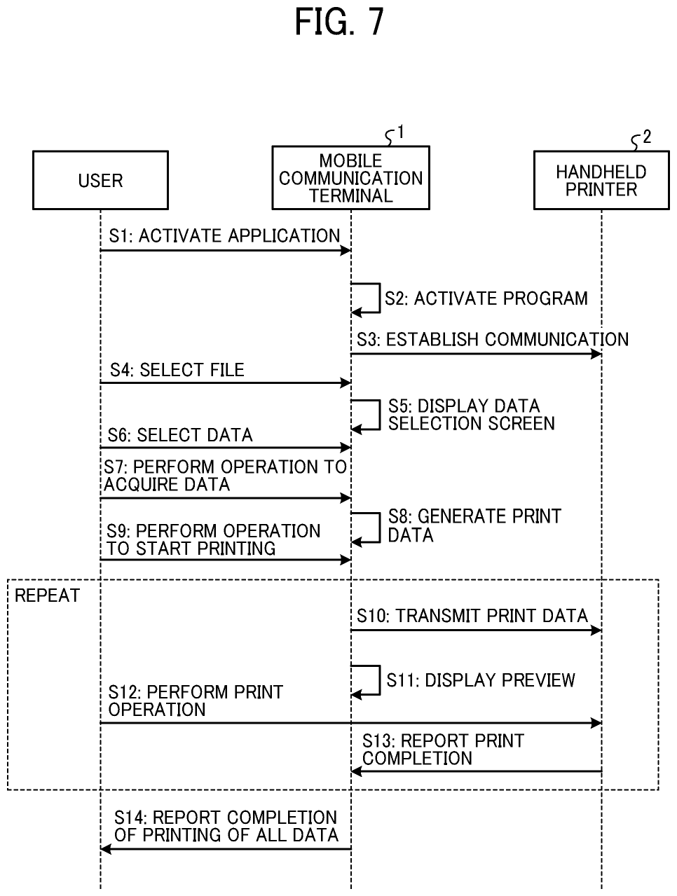

Next, referring to the sequence chart in FIG. 7, a description is given of the printing operation performed by the above-described printing system according to the first embodiment. In FIG. 7, in response to activation operation of the print data generation program (application) on the mobile communication terminal 1 by the user (S1), the input operation acquisition unit 21 of the mobile communication terminal 1 illustrated in FIG. 3 accepts the activation operation (an input operation) and notifies the program activation control unit 22 of the reception of the activation operation. In response to a reception of the notification of the activation operation, the program activation control unit 22 reads out the print data generation program stored in the storage area such as the EEPROM 404 illustrated in FIG. 2 and controls the activation (S2).

In response to the activation of the print data generation program, the communication control unit 24 controls the short-range communication circuit 420 to establish, for example, a BLUETOOTH (registered trademark) communication with the handheld printer 2 (S3).

Next, the user selects (imports) print data (a file) of the print target (S4). The file to be imported is, for example, a file created in advance by the user, and is stored in a storage area such as the RAM 403 or the EEPROM 404 as a file in a predetermined format such as a comma separated value (CSV) format.

The format of the imported data may be a format other than the CSV format. Further, as will be described later, among the imported data, the handheld printer 2 performs the printing on the recording medium 3 using the data selected by the user. The print position is any position on the recording medium 3 designated by the user. Therefore, in the imported data, the print position is not specified.

In response to the reception, by the input operation acquisition unit 21, of the selection of the print data, the display control unit 23 displays the selection screen for the data to be printed in the selected file on the display 418 (S5). The user selects the data according to which printing is performed (data to be acquired) on the print data selection screen (S6), and performs acquisition start operation (S7). As will be described in detail later, the print data generation unit 26 of the mobile communication terminal 1 generates print data that does not cause missing pixels or blurring in the portion of the print object corresponding to the print start position based on the data selected by the user (S8).

In response to setting, by the user, of the number of prints (number of repetitions) and operating of the print start button (S9), the communication control unit 24 of the mobile communication terminal 1 controls the short-range communication circuit 420 to transmit the print data to the handheld printer 2 (S10).

In transmitting the print data to the handheld printer 2, the communication control unit 24 adds information indicating the printing order to the header or the like of each print data and transmits the print data to the handheld printer 2. Alternatively, the communication control unit 24 sequentially transmits the print data one by one (or a plurality of print data at a time) to the handheld printer 2 according to the print order.

The print data may be transmitted to the handheld printer 2, for example, a in first-in first-out (FIFO) transmission mode, such that the data generated earlier is transmitted to the handheld printer 2 earlier.

Alternatively, the print data may be transmitted to the handheld printer 2 in consideration of the memory capacity of the handheld printer 2 as follows. The amount of print data corresponding to the memory capacity is transmitted in the first transmission, and next print data is transmitted after the printing of one print data is completed. Alternatively, the amount of data corresponding to the memory capacity may be transmitted after printing of all the print data is completed.

Further, the display control unit 23 displays animation of an arrow cursor that indicates the operation direction of the handheld printer 2 and moves along the operation direction in addition to displaying the print object such as a character or an image (S11).

For example, when the user selects vertical printing, the display control unit 23 displays, to the user, an animation in which a vertical arrow cursor (upward arrow or downward arrow) moves in the vertical direction, thereby instructing the vertical movement of the handheld printer 2. For example, when the user selects lateral printing, the display control unit 23 displays, to the user, an animation of a lateral arrow cursor (rightward arrow or leftward arrow) that moves in the lateral direction (a preview), thereby instructing the lateral movement of the handheld printer 2.

The user places the handheld printer 2 at a print position on the recording medium 3 and performs print operation, that is, moves the handheld printer 2 in the operation direction indicated by the animation (S12). As a result, a print object such as a desired character or image is printed at a desired position on the recording medium 3.

The handheld printer 2 reports print completion (or sends a print completion notification) to the mobile communication terminal 1 every time the printing of data of one print unit is completed (S13). In response to reception of the print completion notification, the communication control unit 24 of the mobile communication terminal 1 transmits the next print data of one print unit to the handheld printer 2 (S10). Further, the display control unit 23 displays, as preview, the above-described animation of the arrow cursor that indicates the operation direction of the handheld printer 2 corresponding to the transmitted print data (S11). Then, the user performs print operation with the handheld printer 2 (S12). After the printing of data of one print unit is completed, the handheld printer 2 transmits the print completion notification to the mobile communication terminal 1 (S13).

The processing of S10 to S13 is repeated until the printing of all the print data is completed. In response to the completion of printing of all the print data, the display control unit 23 displays a message such as “print complete” on the display 418 to notify the user of the print completion (S14).

Missing Pixels at Print Start Position

As one example, it is assumed that the handheld printer 2 is provided with an inkjet recording head. An inkjet recording head heats each nozzle of the recording head by a heater, thereby reducing the viscosity of the ink in the nozzle, and discharges the ink. For this reason, after a certain length of time elapses from the previous printing, the drying of the ink in the nozzle hinders immediate discharge the ink. As a result, there is a possibility in the next printing that the initial print portion (print start position) of the print object is missing or blurred.

FIGS. 8A and 8B are diagram illustrating the missing or blurred pixels at the start position of a print object. FIG. 8A illustrates a properly printed Chinese character representing “small.” FIG. 8B illustrates the relationship between nozzles (an example of a plurality of discharge portions) of the inkjet recording head 33 and the Chinese character representing “small” in which the pixels corresponding to the start position is missing. In FIG. 8B, the references “N1” to “N10” given to the inkjet recording head 33 indicate first to tenth nozzles (10 nozzles in total) of the inkjet recording head 33. The number of nozzles of the inkjet recording head 33 is one example.

As illustrated in FIG. 8B, when the handheld printer 2 is operated from the left to the right to print the Chinese character representing “small,” the first to third nozzles first print an upper portion of a vertical bar of the Chinese character. Therefore, when a certain time has elapsed from the previous printing, a first missing area MR1 corresponding to three vertical pixels is created in the upper portion of the vertical bar. Further, the fourth to seventh nozzles of the inkjet recording head 33 first print a left part of the Chinese character. Therefore, when a certain time or longer has elapsed from the previous printing, a second missing area MR2 corresponding to four pixels is created in the left part.

Similarly, the eighth nozzle of the inkjet recording head 33 first prints a portion above a turnup portion of the vertical bar of the Chinese character. Therefore, when a certain time or longer has elapsed from the previous printing, a third missing area MR3 corresponding to one pixel is created in the portion above the turnup portion. Similarly, the ninth and tenth nozzles of the inkjet recording head 33 first print the turnup portion of the vertical bar of the Chinese character. Therefore, when a certain time or longer has elapsed from the previous printing, a fourth missing area MR4 corresponding to two pixels is created in the turnup portion.

The following can be clear from the comparison between the properly printed Chinese character illustrated in FIG. 8A and the defective Chinese character illustrated in FIG. 8B. Until the nozzle becomes able to discharge ink normally, ink is not discharged, causing a missing area. Accordingly, the line width of each part of the printed character is reduced (or, the line is blurred due to the decrease in the amount of ink discharged), which is not desirable.

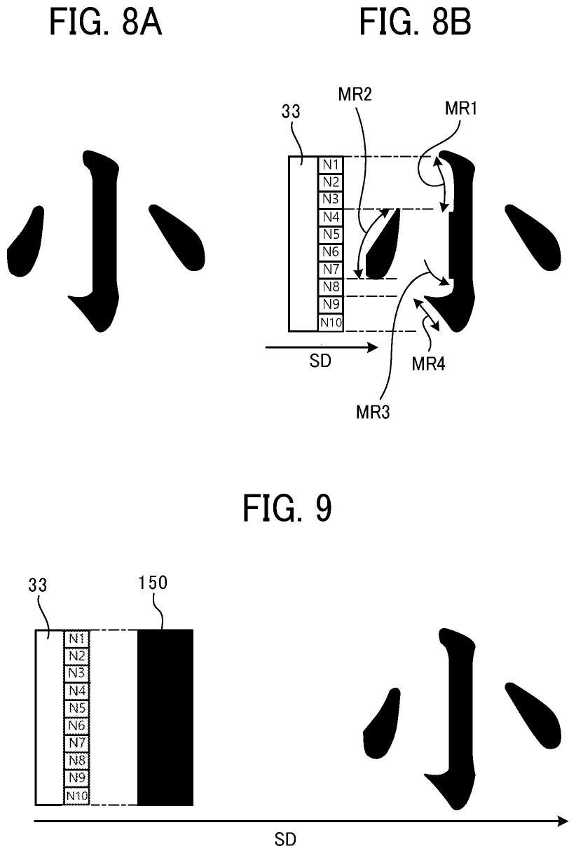

The following is a conceivable approach in order to prevent the occurrence of such a missing area or a blurred portion. As pre-printing, before printing the print object (in the example of FIG. 9, the Chinese character representing “small”), all nozzles may be controlled to discharge ink, to print a black solid object 150 as illustrated in FIG. 9. After the pre-printing, a desired print object (e.g., the Chinese character) is printed.

By the pre-printing of the black solid object 150, printing of a desired object can be started in a state where the nozzles of the inkjet recording head 33 can discharge ink normally. Therefore, the print object can be printed without causing a missing or blurred portion.

However, the example illustrated in FIG. 9 has a drawback. Specifically, by the pre-printing, the black solid object 150 is printed on the recording medium 3 together with the desired print object (e.g., the Chinese character), which is not preferable.

Generation of Print Data

In view of the foregoing, in the printing system according to the first embodiment, in generating the print data in S8 of FIG. 7, pixels corresponding to the print start position of the print object are increased by a predetermined number of pixels, such as 4 to 8 pixels, along the operation direction of the handheld printer 2 (in the direction reverse to the operation direction). The predetermined number can be stored in a memory, for example, by a manufacturer based on empirical data. As a result, the nozzles of the inkjet recording head 33 can operate substantially normally from the start position of the print object, and the print object can be printed without a defect.

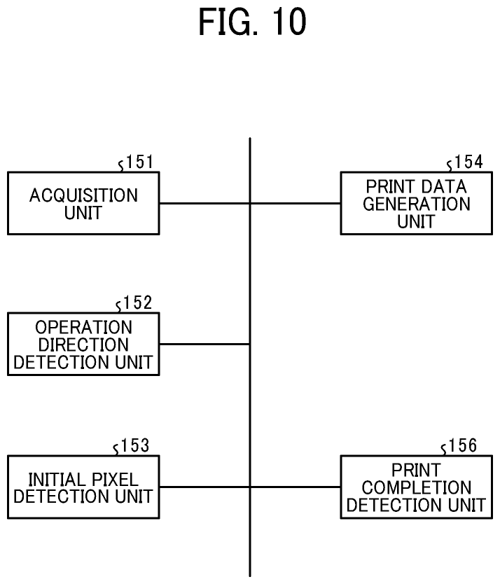

FIG. 10 is a block diagram illustrating a detailed functional configuration of the print data generation unit 26 illustrated in FIG. 3. In other words, when the CPU 401 of the mobile communication terminal 1 functions as the print data generation unit 26 based on the print data generation program, the CPU 401 functions as each function illustrated in FIG. 10 to generate print data. Specifically, when the CPU 401 of the mobile communication terminal 1 functions as the print data generation unit 26, as illustrated in FIG. 10, the CPU 401 functions as an acquisition unit 151, an operation direction detection unit 152, an initial pixel detection unit 153, a print data generation unit 154, and a print completion detection unit 156.

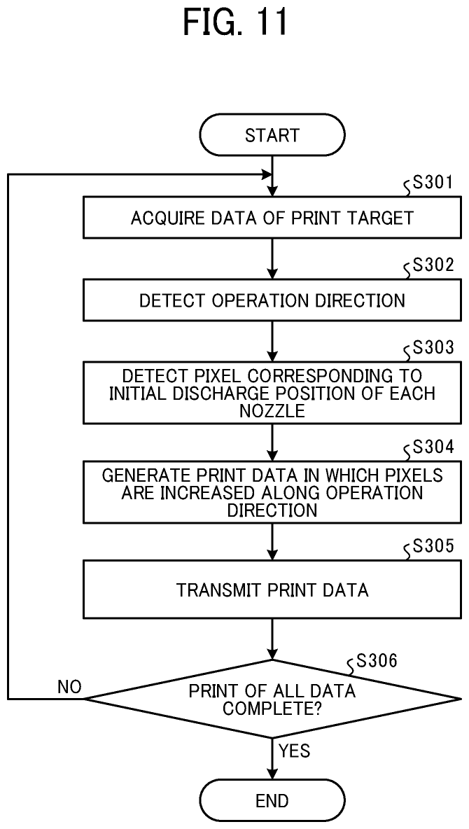

FIG. 11 is a flowchart illustrating the flow of the print data generation operation by the functional units 151 to 154 and 156. In the flowchart of FIG. 11, at the timing to generate the print data (in S8 of FIG. 7), the acquisition unit 151 illustrated in FIG. 10 acquires the data of the print object to be printed (S301). Further, the operation direction detection unit 152 detects the direction in which the handheld printer 2 is operated to print the print object (S302). The operation direction of the handheld printer 2 is determined by default for each object, for example, from right to left, or from top to bottom. Further, the operation direction determined by default can be arbitrarily changed by the user to, for example, from left to right. The operation direction detection unit 152 detects such a default operation direction or an operation direction designated by the user, as the operation direction (or scanning direction) of the handheld printer 2.

Next, the initial pixel detection unit 153 (an example of an identifying unit) detects a pixel (initial pixel) corresponding to the initial discharge position of each nozzle of the inkjet recording head 33 in the print object (S303). The initial pixel is at the print start position of each missing area described above with reference to FIG. 8B.

Next, the print data generation unit 154 generates print data (discharge control data) in which the predetermined number of pixels, such as 4 to 8 pixels, are added to the initial pixel detected in S303, along the operation direction of the handheld printer 2 (S304). In other words, the print data generation unit 154 generates the print data of the target such that the line width is increased along the operation direction of the handheld printer 2 by the predetermined number of pixels (4 to 8 pixels) than the original line width.

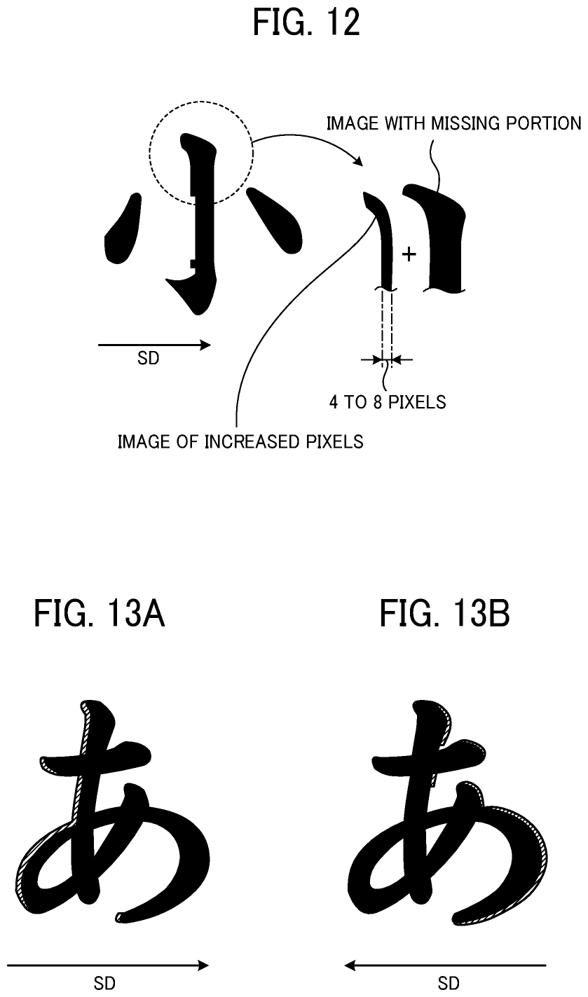

FIG. 12 is a diagram schematically illustrating a print object according to the print data in which the predetermined number of pixels are added along the operation direction of the handheld printer 2. As illustrated in FIG. 12, the following advantage is available by adding the predetermined number of pixels to the initial pixels along the operation direction of the handheld printer 2. In actual printing, each nozzle can discharge ink from the original print start position after performing dummy discharge for, for example, 4 to 8 pixels.

Thus, since the drying of the ink in the nozzles makes ink discharge difficult, the print data generation unit 154 generates print data in which, for example, 4 to 8 pixels are added for dummy discharge to the initial pixels. Therefore, the print object can be printed without a missing area or blurring, and print quality can improve.

FIG. 13A is a schematic diagram illustrating print data generated for printing a hiragana character (Japanese character corresponding to an alphabet “A”) by operating the handheld printer 2 from the left to the right as indicated by arrow SD. In this case, as indicated by diagonal lines in FIG. 13A, print data is generated such that 4 to 8 pixels are added to the initial pixels on the left side of the hiragana character.

FIG. 13B is a schematic diagram illustrating print data generated for printing the hiragana character by operating the handheld printer 2 from the right to the left as indicated by arrow SD. In this case, as indicated by diagonal lines in FIG. 13B, print data is generated such that 4 to 8 pixels are added to the initial pixels on the right side of the hiragana character.

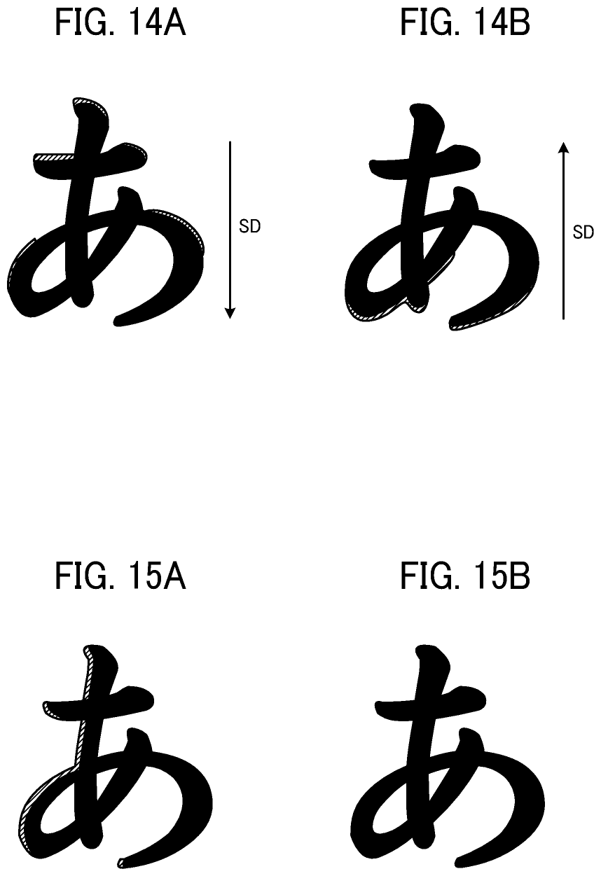

FIG. 14A is a schematic diagram illustrating print data generated for printing the hiragana character by operating the handheld printer 2 downward as indicated by arrow SD. In this case, as indicated by diagonal lines in FIG. 14A, print data is generated such that 4 to 8 pixels are added to the initial pixels on the upper side of the hiragana character.

FIG. 14B is a schematic diagram illustrating print data generated for printing the hiragana character by operating the handheld printer 2 upward as indicated by arrow SD. In this case, as indicated by diagonal lines in FIG. 14B, print data is generated such that 4 to 8 pixels are added to the initial pixels on the bottom side of the hiragana character.

The communication control unit 24 illustrated in FIG. 3 transmits the print data to the handheld printer 2 (S305). The print completion detection unit 156 illustrated in FIG. 10 determines whether or not printing according to all the data is completed based on the print completion report in S13 of FIG. 7. Then, the print data generation unit 26 repeatedly executes the processes of S301 to S306 until the completion of printing according to all data is detect. In response to the detection of the print completion of all data, the print data generation unit 26 ends the print data generation process illustrated in the flowchart of FIG. 11.

The above-described example is effective when the nozzles of the inkjet recording head 33 has such a characteristic that lines of printed characters decreases due to the drying of the nozzles. By contrast, when the nozzles of the inkjet recording head 33 has such a characteristic that lines of printed character are thickened, as indicated by the diagonal line in FIG. 15A, print data is generated such that 4 to 8 pixels are reduced from the initial pixels of the print object (e.g., a hiragana character). As a result, the line of the printed character can be thinned. Then, as illustrated in FIG. 15B, the print object can be printed properly.

As is clear from the above description, in the printing system according to the first embodiment, the mobile communication terminal 1 generates print data in which the initial pixel of the print object in the operation direction of the handheld printer 2 is increased by the predetermined number along the operation direction of the handheld printer 2. Then, the print data is transmitted to the handheld printer 2 to execute printing.

With this configuration, during actual printing, each nozzle can be driven to discharge ink from the original print start position after performing dummy discharge for the increased pixels. Therefore, the print object can be printed without causing a missing area or blurring, and print quality can improve.

A printing system according to a second embodiment is described below. The first embodiment described above is an example of generating print data by the mobile communication terminal 1. On the other hand, the second embodiment described below is an example of generating print data by the handheld printer 2 based on the data received from the mobile communication terminal 1.

In the printing system according to the second embodiment, based on the print control program stored in the ROM 41 (illustrated in FIG. 5) of the handheld printer 2, the handheld printer 2 performs operation similar to that based on the print control program stored in the mobile communication terminal 1 described above. That is, in the second embodiment, based on the print control program stored in the handheld printer 2, the printing system can prevent defects and blurring when printing the above-mentioned object. The second embodiment provides an information processing system that includes a communication terminal including a transmission unit configured to transmit data of the object to be printed on the medium; and a recording device including a communication circuit configured to receive the data from the transmission unit. The recording device further includes an identifying unit, a data generation unit, and a discharge control unit. The identifying unit is configured to identify, based on a movement direction of the recording device in formation of the object on the medium, an initial pixel of the object formed by an initial discharge of the liquid by each of the plurality of discharge portions. The data generation unit is configured to generate discharge control data based on the data received from the communication terminal. The discharge control unit is configured to control the plurality of discharge portions to print, on the medium, the object according to the discharge control data.

Printing Operation of Handheld Printer

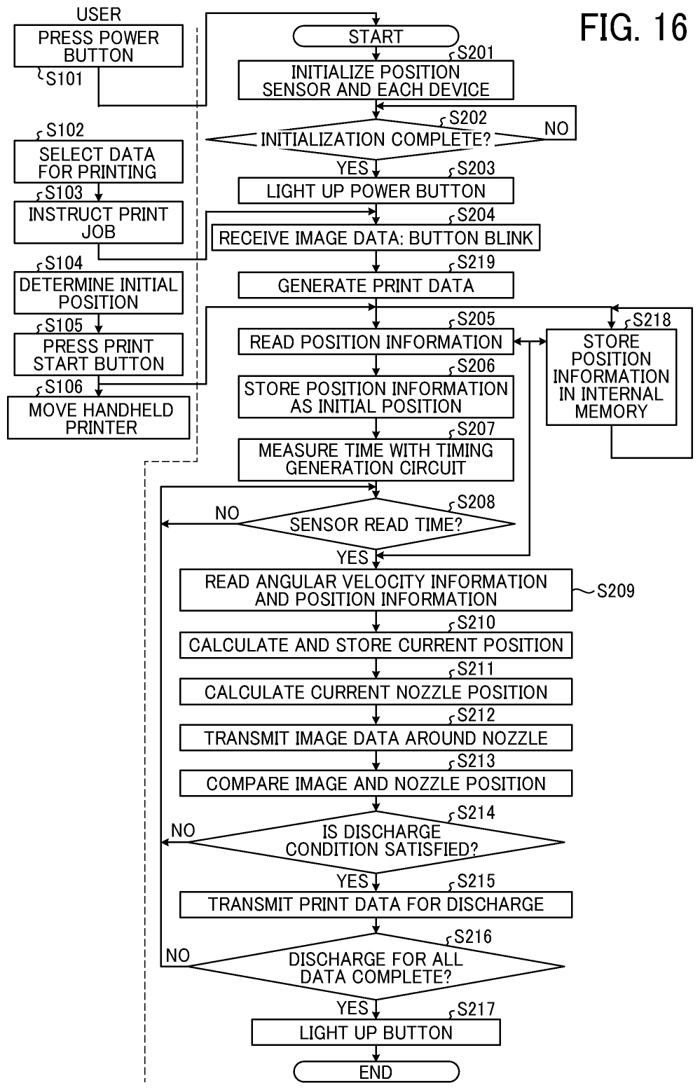

A description is given below of printing operation performed by the handheld printer 2 with reference to FIG. 16. The flowchart in FIG. 16 illustrates an operation performed as the CPU 52, illustrated in FIG. 6, executes the print control program illustrated in FIG. 5.

In S101, the user presses the power button 12 of the handheld printer 2. In response to this operation, power is supplied to each part from the power supply 31 of the handheld printer 2. The SoC 50 (the CPU 52) initializes each electronic device and starts up each device (S201 and S202). After the initialization is completed, for example, the power button 12 is lit up to notify the user that the printing is feasible (S203).

The user selects (and edits) data according to which printing is performed from an image input device such as a personal computer or the mobile communication terminal 1 (S102). The mobile communication terminal 1 transmits print data (i.e., text data or image data selected by the user) in the format of, for example, tagged image file format (TIFF) or Joint Photographic Experts Group (JPEG) based on the above-mentioned print control program or printer driver, for example, via wireless communication (S103). Hereinafter, the term “image data” may be a synonym of “print data.” In response to a reception of the image data, the SoC 50 (the CPU 52) of the handheld printer 2 notifies the user of the reception by, for example, blinking of the print start button 13 (S204).

Further, the CPU 52 generates the print data based on the image data received from the mobile communication terminal 1 to prevent missing pixels or blurring at the position corresponding to the print start position of the print object (S219). Details will be described later.

The user determines the initial position of the handheld printer 2 on the recording medium 3 on which printing is performed (S104), and operates (e.g., presses) the print start button 13 (S105). After that, the user moves the handheld printer 2 on the recording medium 3 (S106). As a result, the print object such as text or image corresponding to the image data is printed on the recording medium 3.

In response to the operation of the print start button 13, the SoC 50 (the CPU 52) of the handheld printer 2 instructs each sensor I/F in the ASIC/FPGA 70 to read the information necessary for the position calculation of the navigation sensor 38. The navigation sensor 38 and the gyro sensor 39 start detecting the position information necessary for position calculation and store the position information in an internal memory (S218).

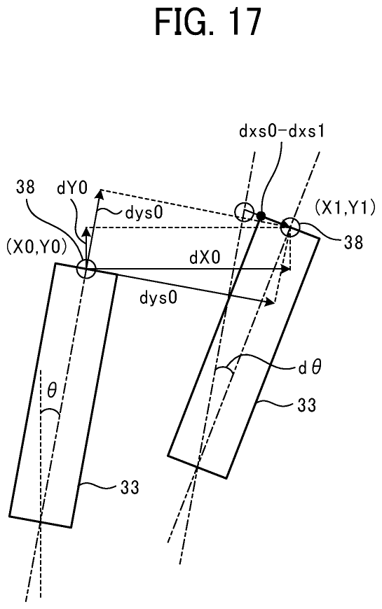

FIG. 17 is a plan view illustrating a position calculation method of the navigation sensor 38. As illustrated in FIG. 17, the obtained angular velocity ω is expressed by Equation 1 below.

$$ω = \frac{d θ}{dt} \qquad Equation 1$$

where dθ represents rotation angle for each sampling period, and dt represents a sampling time. Therefore, an angle dθ for each sampling period is expressed as Equation 2.

dθ=ω×dt Equation 2

Then, a current angle θ (time t=0 to N) is expressed as Equation 3.

$$θ = {\sum }_{t = 0}^{N} ω i \times dt \qquad Equation 3$$

The angle dθ obtained from Equation 2 and the current angle θ obtained from Equation 3 are substituted into Equations 4 to 7 to calculate the two-dimensional coordinates (X1,Y1) from the origin (X0,Y0).

dX₀=dxₛ₀×cos θ+dyₛ₀×sin θ Equation 4

dY₀=−dxₛ₀×sin θ+dyₛ₀×cos θ Equation 5

X1=X₀+dX₀ Equation 6

Y1=Y₀+dY₀ Equation 7

When the coordinates of the navigation sensor 38 is calculated, the coordinates of each nozzle can be calculated by a known calculation based on the mechanical (physical) positional relationship between the navigation sensor 38 and the nozzle since the layout of the devices are determined in advance.

Next, the navigation sensor I/F 72 communicates with the navigation sensor 38 and reads, as position information, the movement amount ΔX in the X-axis direction and the movement amount ΔY in the Y-axis direction of the handheld printer 2. Further, the gyro sensor I/F 75 communicates with the gyro sensor 39 and reads, as position information, the angular velocity ω of the handheld printer 2 (S205). The navigation sensor I/F 72 and the gyro sensor I/F 75 set the position based on the read information as the initial position having, for example, the X coordinate and the Y coordinate “0,0” (S206). After that, the timing generator 73 (a timing generation circuit) inside the ASIC/FPGA 70 measures time (S207). At each read timing set to each sensor (S208), the navigation sensor I/F 72 and the gyro sensor I/F 75 repeat reading of the above-mentioned information (S209).

The value detected by the navigation sensor 38 (movement amounts in the X-axis direction and Y-axis directions) and the value detected by the gyro sensor 39 (angular velocity ω) are necessary for calculating the current two-dimensional position coordinates with respect to the origin. Accordingly, preferably, such information (values) are read simultaneously.

The SoC 50 (the CPU 52) reads information from the ASIC/FPGA 70 and calculates the current position of the handheld printer 2 from the previously calculated position (X,Y), the movement amount (ΔX, ΔY) read at that time, and the angular velocity ω read at that time. Then, the SoC 50 stores the current position in the storage area (S210).

The SoC 50 (the CPU 52) transmits the calculated current position information of the handheld printer 2 to the ASIC/FPGA 70. The ASIC/FPGA 70 calculates the position coordinates of each nozzle (current nozzle position) of the inkjet recording head 33 based on the predetermined relationship between the installation positions of the navigation sensor 38 and the inkjet recording head 33 (S211).

The DMAC (CACHE) 77 and the rotator 78 of ASIC/FPGA 70 read image data around the nozzles of the inkjet recording head 33 from the storage area based on the position information, and rotate the image data (convert the coordinates) in accordance with the designated position and tilt of the inkjet recording head 33 (S212). Then, the coordinates of the image data and each nozzle position are compared (S213). In response to a determination that a set discharge condition is satisfied (S214: Yes), the print data is transmitted to the inkjet recording head controller 74 (S215).

By repeatedly executing the processes from S208 to S215, the SoC 50 (the CPU 52) controls printing of the print object (e.g., an image) on the recording medium 3. In response to a determination that the printing of the entire image is completed (S216: Yes), the SoC 50 (the CPU 52) controls the power button 12 or the print start button 13 to blink (S217) in order to notify the user of the completion of printing.

Even when the printing of the entire image has not been completed, the user may determine that subsequent printing is unnecessary and operate the print start button 13. As a result, subsequent printing is cancelled. Processing in the flowchart illustrated in FIG. 16 can be divided and assigned to the SoC 50 and the ASIC/FPGA 70 according to the performance of the CPU 52, the circuit scale of the ASIC/FPGA 70, and the like.

Print Data Generation Function

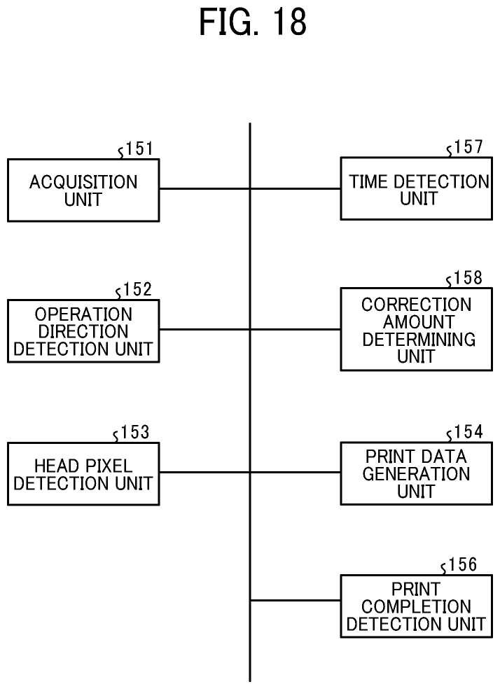

FIG. 18 is a block diagram illustrating a detailed configuration of the print data generation function implemented by the controller 35 executing the print control program provided in the handheld printer 2 of the printing system according to the second embodiment. As illustrated in FIG. 18, in the print data generation in S219, the controller 35 of the handheld printer 2 functions, based on the print control program, as the acquisition unit 151, the operation direction detection unit 152, the initial pixel detection unit 153, the print data generation unit 154, the print completion detection unit 156, a time detection unit 157, and a correction amount determining unit 158, in order to generate print data.

In FIG. 18, the acquisition unit 151 to the print data generation unit 154 and the print completion detection unit 156 operate similar to the acquisition unit 151 to the print data generation unit 154 and the print completion detection unit 156 illustrated in FIG. 10. Therefore, in FIGS. 10 and 18, the functions for the similar operations are designated by the same reference numerals.

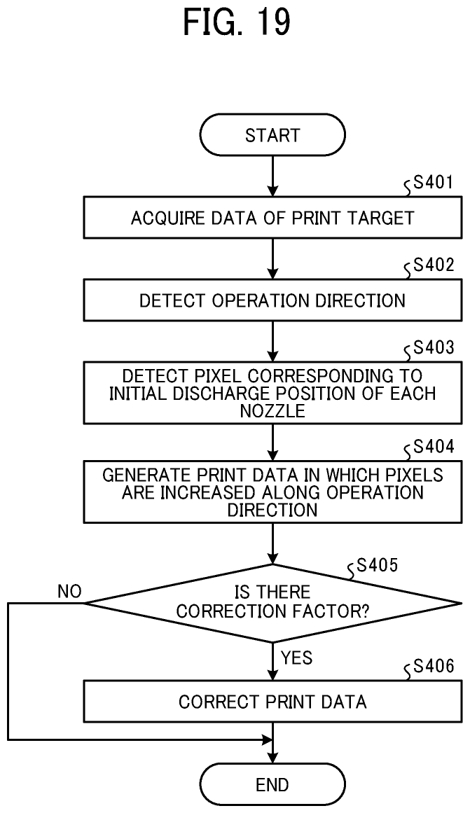

FIG. 19 is a flowchart illustrating in detail the print data generation operation in S219 described above. In the flowchart in FIG. 19, the acquisition unit 151 acquires the image data transmitted from the mobile communication terminal 1 in S103 described above (S401). Further, the operation direction detection unit 152 detects the direction in which the handheld printer 2 is operated in order to print the print object, as described above (S402).

Next, the initial pixel detection unit 153 detects the pixel (initial pixel) corresponding to the initial discharge position of each nozzle of the inkjet recording head 33 in the print object (S403). The initial pixel is at the print start position of each missing area described above with reference to FIG. 8B.

Next, the print data generation unit 154 (an example of a data generation unit) generates print data in which the predetermined number of pixels, such as 4 to 8 pixels, are added to the initial pixel detected in S403, along the operation direction of the handheld printer 2 (S404). In other words, the print data generation unit 154 generates the print data of the target such that the line width is increased along the operation direction of the handheld printer 2 by 4 to 8 pixels than the original line width.

Correction of Print Data

In the printing system according to the second embodiment, the handheld printer 2 corrects the print data generated in step S404, based on correction factors such as “whether or not the head cap 16 is attached” and “time elapsed from removal of the head cap 16 reaches a predetermined time.”

Specifically, in S405, the time detection unit 157 determines the presence or absence of the correction factor described below, and corrects the print data in S406, in response to the detection of the correction factor (S405: Yes). In response to the determination that the correction factor is not present (S405: No), the controller 35 ends the processing of the flowchart of FIG. 19.

Specifically, the handheld printer 2 includes the timer 42 and the head cap detector 43 as illustrated in FIG. 5. The head cap detector 43 detects whether or not the head cap 16 illustrated in FIG. 4 is attached. The correction amount determining unit 158 measures the time elapsed from the detection, by the head cap detector 43, that the head cap 16 is attached (attached state) based on the time information of the timer 42. Further, the CPU 52 measures the time elapsed from the detection, by the head cap detector 43, that the head cap 16 is not attached (non-attached state) based on the time information of the timer 42.

In response to the determination that the measured time is equal to or longer than a predetermined time in both the attached state and the non-attached state, the correction amount determining unit 158 determines in S405 that there is a correction factor (S405: Yes).

More specifically, when the head cap 16 is not attached, the drying of the inkjet recording head 33 advances rapidly. Therefore, the correction amount determining unit 158 determines that the inkjet recording head 33 is dry in response to the measurement of, for example, 30 seconds based on the measured time information, and determines the correction amount of the print data.

By contrast, when the head cap 16 is attached, the drying of the inkjet recording head 33 progresses slowly. Therefore, the correction amount determining unit 158 determines that the inkjet recording head 33 is dry in response to the measurement of, for example, 3 minutes based on the measured time information, and determines the correction amount of the print data.

Determination of the factor “there is a correction factor” in S405 means that the drying of the inkjet recording head 33 has progressed. Therefore, in S406, the print data generation unit 154 further adds, for example, 2 pixels, along the operation direction of the handheld printer 2, to the initial pixel of the print data in which the predetermined number of pixels (e.g., 4 pixels) have been added to the initial pixel in S404, thereby correcting the print data generated in S404.

The correction amount of the initial pixel of the print data may be a fixed amount such as 2 pixels, 4 pixels, or 6 pixels; or the correction amount may be changed according to the above-mentioned elapsed time or the like. For example, the amount of pixels may be increased such that, in the state where the head cap 16 is not attached, 2 pixels are increased in response to elapse of 30 seconds, 4 pixels are increased in response to elapse of 1 minute elapses, and 8 pixels are increased in response to elapse of 3 minutes.

In this way, the printing system measures the elapsed time after the previous printing to the next printing, and corrects the print data generated in S404 according to the threshold of the elapsed time that differs depending on whether or not the head cap 16 is attached, thereby preventing the above-mentioned defect and blurring depending on the degree of drying of the inkjet recording head 33.

Alternatively, the mobile communication terminal 1 can perform such correction of print data. In such a case, the handheld printer 2 transmits, to the mobile communication terminal 1, the information of correction factors, for example, “whether or not the head cap 16 is attached” and “the time elapsed from removal of the head cap 16.”

Such print data is supplied to the inkjet recording head controller 74 in S215 of FIG. 16, as described above. As a result, the print object such as characters or an image corresponding to the print data is printed on the recording medium 3.

As is clear from the above description, in the printing system according to the second embodiment, the handheld printer 2 generates print data in which the initial pixel of the print object in the operation direction of the handheld printer 2 is increased by the predetermined number along the operation direction of the handheld printer 2, and executes the printing.

With this configuration, during actual printing, each nozzle can discharge ink from the original print start position after performing dummy discharge for the increased pixels. Therefore, the print object can be printed without a missing area or blurring, and print quality can improve.

Further, in the printing system according to the second embodiment, the handheld printer 2 measures the time elapsed from the completion of the previous printing, and, when generating the print data, the handheld printer 2 corrects the print data, that is, increases the number of pixels added to the initial pixel, according to the elapsed time. Accordingly, the above-mentioned defects and blurring can be prevented depending on the degree of drying of the inkjet recording head 33.

Although the exemplary embodiments of the disclosure have been described above and illustrated, such description is not intended to limit the scope of the present disclosure to the illustrated embodiments. Thus, numerous additional modifications and variations are possible in light of the above teachings.

For example, elements and/or features of different illustrative embodiments may be combined with each other and/or substituted for each other within the scope of the present disclosure. It is therefore to be understood that within the scope of the appended claims, the embodiments may be practiced otherwise than as specifically described herein. For example, elements and/or features of different illustrative embodiments may be combined with each other and/or substituted for each other within the scope of the present disclosure and appended claims. Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions. The present invention can be implemented in any convenient form, for example using dedicated hardware, or a mixture of dedicated hardware and software. The present invention may be implemented as computer software implemented by one or more networked processing apparatuses. The processing apparatuses can include any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any conventional carrier medium (carrier means). The carrier medium can include a transient carrier medium such as an electrical, optical, microwave, acoustic or radio frequency signal carrying the computer code. An example of such a transient medium is a TCP/IP signal carrying computer code over an IP network, such as the Internet. The carrier medium also includes a storage medium for storing processor readable code such as a floppy disk, hard disk, CD ROM, magnetic tape device or solid state memory device.

This patent application is based on and claims priority to Japanese Patent Application No. 2020-010406, filed on Jan. 24, 2020, in the Japan Patent Office, the entire disclosure of which is hereby incorporated by reference herein.

### REFERENCE SIGNS LIST

1 mobile communication apparatus
2 handheld printer
3 recording medium
11 housing
12 power button
13 print start button
14 guide
15 storage portion
16 head cap
21 input operation acquisition unit
22 program activation control unit
23 display control unit
24 communication control unit
25 storing control unit
26 print data generation unit
41 timer
43 head cap detector
151 acquisition unit
152 operation direction detection unit
153 initial pixel detection unit
154 print data generation unit
156 print completion detection unit
157 time detection unit
158 correction amount determining unit

1. An information processing device for generating data to be used by a recording device to form an object on a medium, the recording device including a recording head including a plurality of discharge portions configured to discharge a liquid, to form the object on the medium, the information processing device comprising:
communication circuitry configured to communicate with the recording device;
identifying circuitry configured to identify, based on a movement direction of the recording device in formation of the object on the medium, an initial pixel of the object formed by an initial discharge of the liquid by each of the plurality of discharge portions;
data generation circuitry configured to generate discharge control data for controlling a discharge operation of each of the plurality of discharge portions for the initial pixel identified by the identifying circuitry; and
transmission control circuitry configured to control the communication circuity to transmit the discharge control data to the recording device.

2. The information processing device according to claim 1,
wherein the data generation circuitry is configured to generate the discharge control data for controlling each of the plurality of discharge portions to perform the discharge operation before forming the initial pixel on the medium.

3. The information processing device according to claim 1,
wherein the data generation circuitry is configured to generate the discharge control data in which a predetermined number of pixels are added to the initial pixel of the object along a direction reverse to the movement direction.

4. An information processing system comprising:
a communication terminal including the information processing device according to claim 1; and
the recording device including:
communication circuitry configured to receive the discharge control data from the communication terminal; and
discharge control circuitry configured to control the plurality of discharge portions to print, on the medium, the object according to the discharge control data received from the communication terminal.

5. A method for generating data to be used by a recording device to form an object on a medium, the recording device including a recording head including a plurality of discharge portions configured to discharge a liquid, to form the object,
the method comprising:
identifying, based on a movement direction of the recording device in formation of the object on the medium, an initial pixel of the object formed by an initial discharge of the liquid by each of the plurality of discharge portions; and
generating discharge control data for controlling a discharge operation of each of the plurality of discharge portions for the initial pixel identified.

6. The method according to claim 5,
wherein the generating includes generating the discharge control data for controlling each of the plurality of discharge portions to perform the discharge operation before forming the initial pixel on the medium.

7. The method according to claim 5,
wherein the generating includes adding, in the discharge control data, a predetermined number of pixels to the initial pixel of the object along a direction reverse to the movement direction.

8. A non-transitory computer readable medium including computer code which when executed causes a computer to carry out the method according to claim 5.
